(19) United States
(12) Patent Application Publication
(10) Pub. No.: US 2026/0102026 A1
(43) Pub. Date: Apr. 16, 2026

(54) SHAFT MOUNTABLE FORKED TOOL

(71) Applicant: Benjamin Gary Baader, Onoway (CA)

(72) Inventor: Benjamin Gary Baader, Onoway (CA)

(21) Appl. No.: 19/360,319

(22) Filed: Oct. 16, 2025

Related U.S. Application Data
(60) Provisional application No. 63/707,788, filed on Oct. 16, 2024.

(51) Int. Cl. A47J 43/18

(52) U.S. Cl. CPC A47J 43/18

(57) ABSTRACT

A forked tool has a sleeve portion formed of helically wound wire and two spaced apart tines extending longitudinally from the sleeve portion. The helical wire segments of the sleeve portion are resilient so as to be circumferentially and longitudinally expandable for releasable threaded attachment onto various shafts including different sizes and irregularly shaped branches and the like. The forked tool is thus highly adaptable to a large variety of uses as a cooking utensil, as a structural connector, or as a support/stand for various objects when attached to readily available branches. When separated from the shaft, the tool alone remains lightweight and easily transportable for ease of use in various outdoor activities including hiking, hunting, camping and the like.

This application claims the benefit under 35 U.S.C.119(e) of U.S. provisional application Ser. No. 63/707,788, filed Oct. 16, 2024.

### FIELD OF THE INVENTION

The present invention relates to a forked tool arranged for releasable attachment to a shaft, for example a branch or a pole, in which the forked tool includes a pair of tines protruding longitudinally of the shaft to define a fork.

### BACKGROUND

When cooking food items over an open fire, for example wieners, game meat or marshmallows, it is common to use a forked tool in which two or more tines protrude in fixed relation from the end of a shaft. The tines are penetrated into the food item so that a user gripping the shaft can suspend the food item over the fire while remaining safely distanced from the fire. The shaft can be long and awkward to store and transport when performing such activities as hiking, hunting, or camping for example.

U.S. Pat. No. 6,754,966 describes one example of a forked tool in which the tines are mounted onto a telescoping shaft. Although this simplifies storage and transport of the tool, the numerous parts required to form the telescoping shaft arrangement may be complex and costly to manufacture.

Furthermore, prior art forked tools, like U.S. Pat. No. 6,754,966 noted above, are typically limited to a singular use such as a cooking utensil due to the configuration of the forks and the limitations of the associated shaft.

### SUMMARY OF THE INVENTION

According to one aspect of the invention there is provided a forked tool for releasable attachment to a shaft, the tool comprising:
a sleeve portion having a tubular shape extending longitudinally between a proximal end and a distal end of the sleeve portion in which the distal end is open so as to be arranged to receive the shaft inserted therein; and
two tines protruding longitudinally from the proximal end of the sleeve portion in spaced apart relation to one another;
wherein the sleeve portion is configured for threaded attachment onto the shaft; and
wherein the sleeve portion is resiliently deformable.

Preferably the sleeve portion is formed of at least one metallic wire that is helically wound so as to define a plurality of helical segments supported longitudinally adjacent one another.

Preferably the helical segments are resiliently expandable relative to one another in a circumferential direction and/or in a longitudinal direction of the sleeve portion.

According to a second aspect of the present invention there is provided a method of using the forked tool comprising:
forming the shaft from a tree branch; and
rotating the sleeve portion of the tool relative to the shaft as the shaft is inserted into the sleeve portion to screw the shaft into the sleeve portion.

By providing a sleeve portion which is resiliently deformable and configured for threaded attachment onto the shaft, the tool can adapt to a variety of different shaft shapes and sizes so that the tool can accommodate shafts made from readily available tree branches and the like. Accordingly, when enjoying outdoor activities such as hiking, hunting or camping, only the forked tool requires transport as the tool can be readily assembled onto any suitable branch or stick instead of also transporting a shaft with the tool. The use of a helically wound metallic wire also results in a sleeve portion which is simple and of low-cost to manufacture, while remaining adaptable to different shaft sizes and configurations.

The ability of the sleeve portion to adapt to a variety of different shafts, for example made from tree branches or sticks of varying sizes, also results in the forked tool being highly adaptable to a large variety of uses as a cooking utensil, as a structural connector, or as a support/stand for various objects.

The adaptability of the sleeve portion also allows the user to select larger and more durable branches for applications where greater strength is required, while selecting lighter and smaller branches for other uses, while the tool itself remains small and portable for transport into backcountry environments once detached from the shaft. The resulting assembly of the forked tool mounted on the end of a shaft can thus be made to be much more robust than conventional forked tools.

The proximal end of the sleeve portion may include a proximal opening formed therein through which the shaft can be received.

When each tine is connected to the sleeve portion by a supporting arm, the supporting arms may be mounted tangentially in relation to the proximal opening at diametrically opposing sides of the sleeve portion.

The tines are preferably formed of respective wire members that extend continuously from said at least one metallic wire of the sleeve portion.

In the illustrated embodiment, said at least one metallic wire preferably comprises two metallic wires which are supported longitudinally adjacent one another and which extend helically about an axis of the sleeve portion along a length of the sleeve portion, in which the tines extend continuously from respective ones of the two metallic wires.

Am inner diameter of the sleeve portion may vary along a length of the sleeve portion.

The sleeve portion preferably includes a straight portion adjacent the distal end in which the inner diameter is constant in a relaxed state of the sleeve portion. The straight portion preferably spans a majority of a length of the sleeve portion. The sleeve portion may also include a tapered portion adjacent the proximal end in which the inner diameter is gradually reduced towards the proximal end. More particularly, the proximal end of the sleeve portion may include a proximal opening formed therein through which the shaft can be received, in which the inner diameter of the tapered portion varies between a first diameter corresponding to the straight portion and a second diameter corresponding to the proximal opening.

### BRIEF DESCRIPTION OF THE DRAWINGS

One embodiment of the invention will now be described in conjunction with the accompanying drawings in which:

FIG. 1 is a perspective view of the forked tool according to the present invention;

FIG. 2 is a top plan view of the forked tool of FIG. 1;

FIG. 3 is a front elevational view of the forked tool of FIG. 1;

FIG. 4 is a front elevational view of the forked tool of FIG. 1;

FIG. 5 is a sectional view along the line 5-5 in FIG. 2 in which the tool is shown mounted on the end of a stick;

FIG. 6 is a front elevational view of the forked tool of FIG. 1 when used as a stand or rest for another transverse object; and

FIG. 7 is a partly sectional view of two forked tools according to FIG. 1 mounted along a common shaft when used as a roasting spit.

In the drawings like characters of reference indicate corresponding parts in the different figures.

### DETAILED DESCRIPTION

Referring to the accompanying figures, there is illustrated a shaft mountable forked tool generally indicated by reference numeral 10. The tool 10 is arranged for releasable attachment to a shaft 12 such as a pole or stick, which may be formed from a tree branch as required. In one preferred use, the tool 10 is arranged to mount a food item 13 thereon such that the food item can be supported on the shaft whereby a person gripping the shaft can suspend the food item 13 over an open fire while remaining safely distanced from the fire.

The tool 10 generally comprises (i) a sleeve portion 14 that has a tubular shape for receiving the shaft 12 inserted therein and (ii) two tines 16 protruding in a longitudinal direction from one end of the sleeve portion 14. The sleeve portion 14 has a generally tubular shape extending longitudinally between a distal end 18 having a distal opening 20 therein to receive the end of the shaft 12 inserted into the sleeve portion and a proximal end 22 from which the tines protrude in the longitudinal direction corresponding to an axial direction of the sleeve portion. The sleeve portion is resiliently deformable to expand circumferentially and/or longitudinally so as to be adaptable to mount securely and snugly onto a variety of different shaft diameters. Furthermore, the sleeve portion 14 includes a helical feature, described in further detail below, which at least partly defines an inner surface of the sleeve portion such that the sleeve portion is adapted to be screwed onto the shaft to formed a threaded attachment of the sleeve portion 14 onto the shaft 12.

The tubular shape of the sleeve portion 14 is formed by two metallic wires 24 which are sufficiently rigid to be self-supporting in shape while being resilient so as to be biased to return to their original shape after being deformed. The metallic wires 24 are directly adjacent one another in the axial or longitudinal direction of the sleeve portion and extend helically about a central axis of the tubular shape from first ends 26 of the wires located at diametrically opposing sides of the sleeve at the distal end 18 thereof to opposing second ends 28 situated at the proximal end at diametrically opposing sides of a proximal opening 38 at the proximal end. The proximal opening 30 is smaller in diameter than the distal opening 20 but remains arranged to receive the shaft 12 inserted fully through the sleeve portion in some applications.

Each full rotation of each metallic wire 24 that extends helically about the sleeve portion defines a respective helical segment of the wire which is continuous with the other helical segments of the wire along a length of the wire. The metallic wires 24 are axially adjacent one another as they extend helically along the sleeve portion such that the wall of the sleeve portion is defined by axially adjacent helical segments in which the helical segments alternate in the axial direction between a helical segment of a first one of the metallic wires 24 and a helical segment of a second one of the metallic wires 24. Although the helical segments are directly adjacent one another continuously along the length of the sleeve portion, the helical segments remain separate from one another other than being formed continuously in the helical direction such that adjacent helical segments are resiliently movable relative to one another to vary in circumference or vary in spacing in the axial direction as the sleeve portion is mounted onto a shaft 12 as described in further detail below.

The tubular shape of the sleeve portion 14 includes a straight portion 32 adjacent to the distal end in which an interior diameter remains constant, corresponding to the interior diameter of the distal opening 20. The straight portion 32 spans a majority of the overall length of the sleeve portion. The tubular shape of the sleeve portion 14 further includes a tapered portion 34 adjacent the proximal end so as to span between the straight portion 32 and the proximal end in which an interior diameter is gradually reduced from a first diameter corresponding to the interior diameter of the straight portion 32 to a second diameter corresponding to the inner diameter of the proximal opening 30.

Due to the body of the sleeve portion being formed by the helically wound metallic wires 24, including the inner surface of the tubular shape which is likewise defined by the helical wires, the resulting inner surface comprises helical segments of the wire that define helical threads functioning as internal threading of a threaded socket. This helical feature on the inner surface of the sleeve portion engages the cylindrical outer surface of a shaft inserted into the sleeve portion to allow the shaft to be threaded or screwed into the sleeve portion during assembly. More particularly, rotating the sleeve portion 14 relative to the shaft assists in guiding longitudinal insertion of the shaft into the sleeve portion. During this process, the helical segments of the metallic wires 24 being resiliently deformable axially and longitudinally relative to one another accommodates for any irregularities in the outer surface of the shaft, for example when the shaft comprises a tree branch or other elongated pole structure having an irregular surface.

The tines 16 of the tool each comprise a respective wire member in which each wire member is formed integrally and continuously as a single wire together with a respective one of the metallic wires 24 of the sleeve portion. More particularly, each tine includes a main tine body 36 supported such that the time bodies 36 are parallel to the longitudinal axis of the sleeve portion such that the two tines are spaced radially outward at diametrically opposing locations relative to the sleeve portion. Each tine body includes a distal end 38 which is sloped to define a pointed tip that eases penetration of the tine into the food item 13.

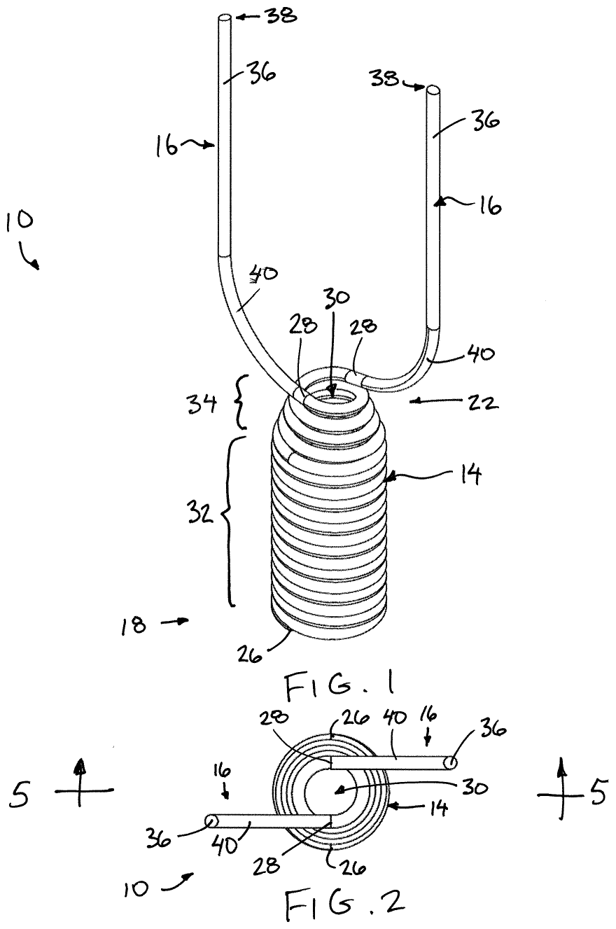

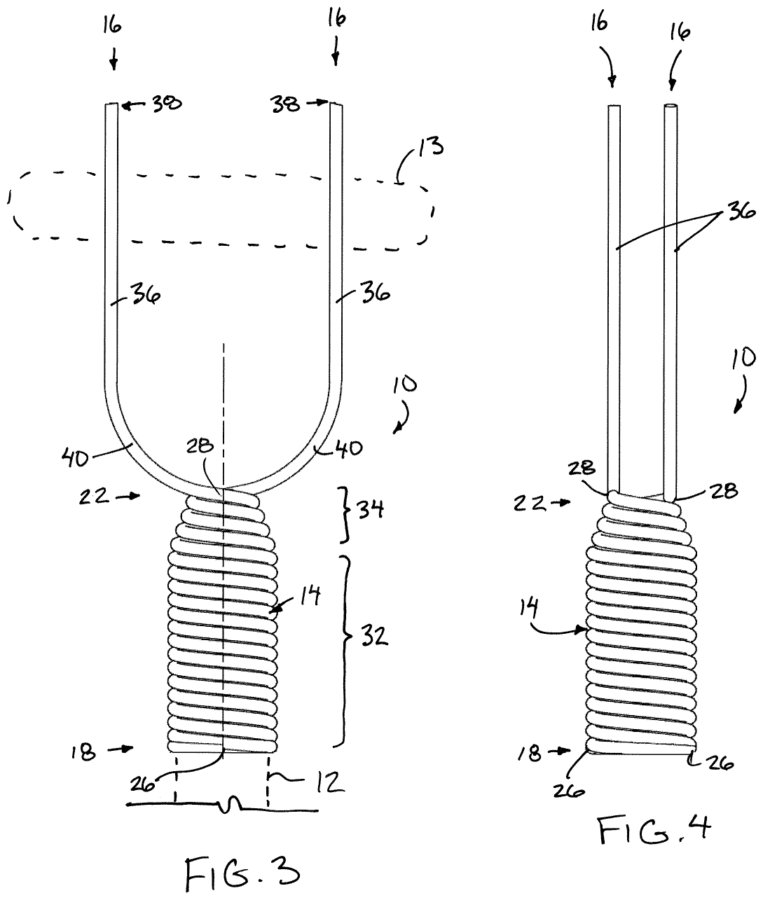

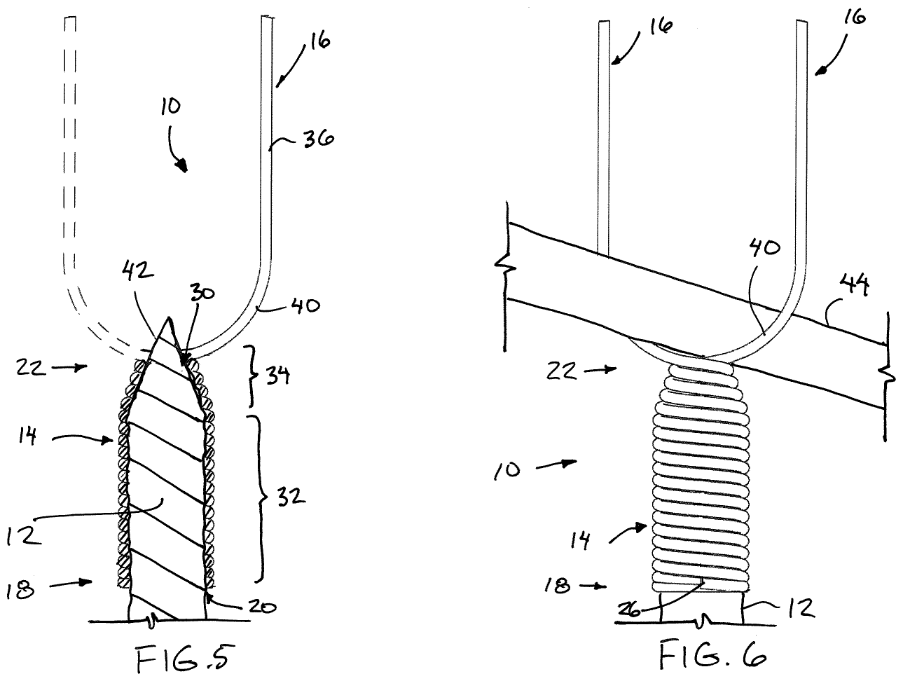

Each tine 16 further includes a supporting arm 40 that extends outward and continuously with the second end 28 of the respective metallic wire 24. The supporting arms 40 extend outward from the metallic wires 24 at diametrically opposing sides of the proximal opening 30 to be joined to the two main tine bodies 36 respectively. As best seen in FIG. 2, each supporting arm 40 extends tangentially to the proximal opening 30 as the supporting arm extends between the sleeve portion 14 and the respective tine body 36. Each supporting arm 40 is gradually curved along the length thereof from a tangential orientation at a first end connected integrally with the respective metallic wire 24 to an axial orientation at the opposing end joined to the tine body 36.

In order to use the tool 10, a shaft 12 is first prepared from a branch or stick, for example by using a knife to produce a tapered end 42 on the end of the branch. The tapered end 42 of the shaft is inserted into the sleeve portion while rotating the sleeve portion relative to the shaft so that the helical windings of the metallic wires 24 form a threaded connection with the shaft. The resilient nature of the wires 24 ensures that the sleeve portion can expand to accommodate irregularities or variations in the outer diameter and general shape of the shaft. While deforming around the shaft, the metallic wires 24 remain biased to return to their original diameter which functions to securely clamp the sleeve portion snugly about the shaft in a mounted position. The tapered end 42 of the shaft may protrude through the proximal opening 30 when the shaft is fully inserted into the sleeve portion. Once the tool 10 has been mounted on the shaft, a food item can be supported on the tool by penetrating the tines into the food item. The user then grips the end of the shaft opposite the tool 10 so that the tool can be used to suspend the food item over an open fire while the user remains safely distance from the fire. When cooking of the food item is complete, the tool 10 can be readily released from the shaft by again rotating the sleeve portion relative to the shaft so that the internally threaded feature of the sleeve portion easily releases the shaft from the sleeve portion in a threaded manner even when the shaft is tightly gripped within the sleeve portion.

In this manner the tool 10 is well-suited for supporting food items over an open fire including sausage, wieners, marshmallows and the like. In addition, the tool can be used to support various types of game meat thereon including birds, squirrels, fish, rabbit and the like, or trimmed steaks from larger game.

In other applications, mounting the tool 10 onto a shaft 12 as described above can be used as a pickup tool, as a hunting tool including use as a fishing spear and the like, or as protection from wildlife.

In other instances, when the tool is mounted on one end of a shaft 12 and the other end of the shaft is engaged upon or planted in the ground. With the shaft in an upright orientation, the tines 16 form a U-shaped cradle or yoke which is suitable for supporting various elongated members 42 extending transversely to the shaft through the cradle. For example, the tool can be used with a shaft to form a mono pole rifle stand when the elongated member comprises the barrel of a rifle. In other instances, the elongated member 44 may comprise a beam for a tent or lean-to structure supported by the tool 10 at the end of a pole forming the shaft.

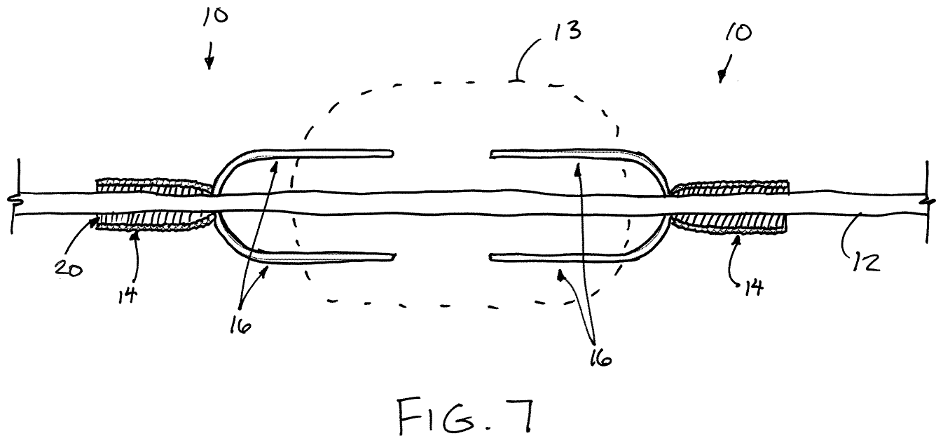

In yet a further instance, a pair of tools 10 may be supported by horizontally spaced and vertically oriented shafts so that the elongated member 44 that extends across the tools comprises a roasting spit for supporting larger game thereon. As shown in FIG. 7 for instance, the tool 10 can also be used in forming a roasting spit assembly of the type supported on stands configured as shown in FIG. 6. In the roasting spit assembly of FIG. 7, a single branch or shaft 12 forms the primary member of a spit while two tools 10 are supported on the shaft 14 so that the shaft passes fully through the distal and proximal openings of the sleeve portions of the tools. Each tool 10 is mounted at an intermediate location along the shaft such that the tools are oriented in opposing directions with their tines 16 pointed towards one another. A shaft 12 is selected so that the diameter passes through the proximal openings with some expansion of the proximal openings so that the sleeve portions remain biased in a snug clamping configuration about the shaft in a substantially fixed and immovable manner until the tools are ready for removal from the shaft by unthreading. The tines of the two opposing tools 10 assist in supporting a larger food item 13 supported on the spit assembly.

Since various modifications can be made in the invention as herein above described, and many apparently widely different embodiments of same made, it is intended that all matter contained in the accompanying specification shall be interpreted as illustrative only and not in a limiting sense.

1. A forked tool for releasable attachment to a shaft, the tool comprising:
a sleeve portion having a tubular shape extending longitudinally between a proximal end and a distal end of the sleeve portion in which the distal end is open so as to be arranged to receive the shaft inserted therein; and
two tines protruding longitudinally from the proximal end of the sleeve portion in spaced apart relation to one another;
wherein the sleeve portion is configured for threaded attachment onto the shaft; and
wherein the sleeve portion is resiliently deformable.

2. The tool according to claim 1 wherein the sleeve portion is formed of at least one metallic wire that is helically wound so as to define a plurality of helical segments supported longitudinally adjacent one another.

3. The tool according to claim 1 wherein the helical segments are resiliently expandable relative to one another in a circumferential direction of the sleeve portion.

4. The tool according to claim 1 wherein the helical segments are resiliently expandable relative to one another in a longitudinal direction of the sleeve portion.

5. The tool according to claim 1 wherein the proximal end of the sleeve portion includes a proximal opening formed therein through which the shaft can be received.

6. The tool according to claim 5 wherein each tine is connected to the sleeve portion by a supporting arm, the supporting arms being mounted tangentially in relation to the proximal opening at diametrically opposing sides of the sleeve portion.

7. The tool according to claim 1 wherein the tines are formed of respective wire members that extend continuously from said at least one metallic wire of the sleeve portion.

8. The tool according to claim 7 wherein said at least one metallic wire comprises two metallic wires which are supported longitudinally adjacent one another and which extend helically about an axis of the sleeve portion along a length of the sleeve portion, and wherein the tines extend continuously from respective ones of the two metallic wires.

9. The tool according to claim 1 wherein an inner diameter of the sleeve portion varies along a length of the sleeve portion.

10. The tool according to claim 9 wherein the sleeve portion includes a straight portion adjacent the distal end in which the inner diameter is constant in a relaxed state of the sleeve portion.

11. The tool according to claim 10 wherein the straight portion spans a majority of a length of the sleeve portion.

12. The tool according to claim 10 wherein the sleeve portion includes a tapered portion adjacent the proximal end in which the inner diameter is gradually reduced towards the proximal end.

13. The tool according to claim 12 wherein the proximal end of the sleeve portion includes a proximal opening formed therein through which the shaft can be received, and wherein the inner diameter of the tapered portion varies between a first diameter corresponding to the straight portion and a second diameter corresponding to the proximal opening.

14. A method of using the tool according to claim 1, the method comprising:
forming the shaft from a tree branch; and
rotating the sleeve portion of the tool relative to the shaft as the shaft is inserted into the sleeve portion to screw the shaft into the sleeve portion.
